(19) United States
(12) Patent Application Publication
(10) Pub. No.: US 2009/0181260 A1
(43) Pub. Date: Jul. 16, 2009

(54) Alkanolamine-modified phenolic resin formulation and coatings for abrasive products

(75) Inventors: Jagmohan Verma, Durgapur (IN); Adiseshaiah K. Seshu, Shanghai (CN); Abdul Habid Pullichola, Kavanur (IN); Olivier Pons Y. Moll, Agnetz (FR); Philippe Espiard, Gouvieux (FR)

Correspondence Address: HAMILTON, BROOK, SMITH & REYNOLDS, P.C., 530 VIRGINIA ROAD, P.O. BOX 9133, CONCORD, MA, 01742-9133, US

(73) Assignees: Saint-Gobain Abrasive, Inc., Worcester, MA (US); Saint-Gobain Abrasifs, Honorine (FR)

(21) Appl. No.: 12/315,501

(22) Filed: Dec. 3, 2008

Related U.S. Application Data
(60) Provisional application No. 61/005,325, filed on Dec. 4, 2007.

(51) Int. Cl. B32B 27/42; C08G 65/40; C08J 3/28; C08G 14/073; B24D 11/00

(52) U.S. Cl. 428/524; 528/211; 51/295; 524/595

(57) ABSTRACT

An alkanolamine-modified phenolic resin formulation is formed by reacting a basic catalyst, formaldehyde, water and a benzene-ol to form an intermediate composition to which and an alkanolamine is subsequently added to reduce the presence of free formaldehyde. The alkanolamine-modified phenolic resin formulation can be employed to coat abrasive products having a relatively low free formaldehyde content.

### RELATED APPLICATION

This application claims the benefit of U.S. Provisional Application No. 61/005,325, filed on Dec. 4, 2007.

The entire teachings of the above application are incorporated herein by reference.

### BACKGROUND OF THE INVENTION

Resoles are fusable resins soluble in alkali and alcohol and that are formed by an alkaline condensation of phenol and an aldehyde to form a phenolic resin. Phenolic resins are commonly used in laminating and impregnating paper and fabrics, and in forming coatings for abrasive products. Free formaldehyde generally is a by-product of forming phenolic resins that can be released during manufacture of abrasive products coated with phenolic resin. Formaldehyde may represent a potential health hazard.

Depending upon the application, polyacrylamide urea and other compounds have been employed to scavenge formaldehyde to thereby minimize its release during processing and use of phenolic resins. However, known scavengers can deleteriously affect the handling characteristics of the resins with which they are combined, and can limit performance of products incorporating such resins.

Therefore, a need exists for phenolic resin formulations, particularly with respect to coatings of abrasive products, that minimize or eliminate the potential hazard associated with release of formaldehyde, without detracting from the performance of products incorporating phenolic resins.

### SUMMARY OF THE INVENTION

This invention is directed to a method of forming a phenolic resin formulation having a reduced formaldehyde content, and to abrasive products and methods of making abrasive products that incorporate phenolic resin formulations having a reduced formaldehyde content.

In one embodiment, the invention is directed to a method of forming a alkanolamine-modified phenolic resin having a reduced formaldehyde content. The method includes combining a basic catalyst, formaldehyde, water and a benzene-ol to form a reaction mixture undergoing chemical reaction. The reaction is terminated when water tolerance of the reaction mixture is in a range of between about 150% and about 1000% to thereby form an intermediate composition. An alkanolamine is then added to the intermediate composition in an amount of between about 0.5 weight % and about 15 wt % of the weight of the benzene-ol combined to form the reaction mixture, whereby the alkanolamine undergoes chemical reaction with the intermediate composition to thereby form the alkanolamine-modified phenolic resin.

In another embodiment, the invention is an alkanolamine-modified phenolic resin formulation comprising an alkanolamine-modified phenolic resin formed by the method of the invention described above.

In yet another embodiment, an abrasive article is formed by a method that includes forming a curable resin composition that includes an alkanolamine-modified phenolic resin, contacting a plurality of abrasive particles with the curable resin composition, and curing the curable resin composition to product the abrasive product. The alkanolamine-modified phenolic resin formulation is formed by a method that combining a basic catalyst, formaldehyde, water and a benzene-ol to form a reaction mixture undergoing chemical reaction. The reaction is terminated when water tolerance of the reaction mixture is in a range of between about 150% and about 1000% to thereby form an intermediate composition. An alkanolamine is then added to the intermediate composition in an amount of between about 0.5 weight % and about 15 wt % of the weight of the benzene-ol combined to form the reaction mixture, whereby the alkanolamine undergoes chemical reaction with the intermediate composition to thereby form the alkanolamine-modified phenolic resin.

In yet another embodiment, the invention is an abrasive product formed by the method of the invention.

In yet another embodiment, a coated abrasive product is formed by a method that includes combining a basic catalyst, formaldehyde, water and a benzene-ol to form a reaction mixture undergoing chemical reaction. The reaction is terminated when water tolerance of the reaction mixture is in a range of between about 150% and about 1000 to thereby form an intermediate composition. An alkanolamine is then added to the intermediate composition in an amount of between about 0.5 weight % and about 15 wt % of the weight of the benzene-ol combined to form the reaction mixture, whereby the alkanolamine undergoes chemical reaction with the intermediate composition to thereby form the alkanolamine-modified phenolic resin. A coating that includes the alkanolamine-modified phenolic resin is applied to an abrasive product, and the coating is then cured to form the coated abrasive product.

In yet another embodiment, the invention is a coated abrasive product formed by the method of the invention.

In yet another embodiment, a bonded abrasive product is formed by a method that includes combining a basic catalyst, formaldehyde, water and a benzene-ol to form a reaction mixture undergoing chemical reaction. The reaction is terminated when water tolerance of the reaction mixture is in a range of between about 150% and about 1000 to thereby form an intermediate composition. An alkanolamine is then added to the intermediate composition in an amount of between about 0.5 weight % and about 15 wt % of the weight of the benzene-ol combined to form the reaction mixture, whereby the alkanolamine undergoes chemical reaction with the intermediate composition to thereby form the alkanolamine-modified phenolic resin. The alkanolamine-modified phenolic resin is mixed with abrasive particles, and the mixture is formed into a desired shape. The coating is then cured to form the bonded abrasive product.

In yet another embodiment, the invention is a bonded abrasive product formed by the method of the invention.

In still another embodiment of the invention, an alkanolamine-modified phenolic resin formulation having a reduced formaldehyde content is formed by combining formaldehyde, phenol in a molar ratio to the formaldehyde in a range of between about 1:1 and about 1:2.3, and sodium hydroxide in an amount in a range of between about 1% and about 5% by weight of the phenol, to thereby form a reaction mixture undergoing chemical reaction. Temperature of the reaction mixture is adjusted to have a temperature in a range between about 85° C. and about 95° C. The reaction of the reaction mixture is terminated by lowering the temperature to a temperature equal to or less than about 50° C., when water tolerance of the reaction mixture is in a range between about 150% and about 1000% to thereby form an intermediate composition. An alkanolamine is added to the intermediate composition in an amount in a range of between about 0.5 wt % and about 15 wt % of the amount of the phenol combined to form the reaction mixture. The temperature of the mixture of the alkanolamine and the intermediate composition is adjusted to a temperature in a range of between about 55° C. and about 65° C., whereby the alkanolamine undergoes chemical reaction with the intermediate composition. At least a portion of water from the reaction mixture is removed by a vacuum distillation to thereby obtain an alkanolamine-modified phenolic resin formulation having a viscosity in a range of between about 2,000 cps and about 20,000 cps at about 25° C. is formed.

This invention has many advantages. For example, the formaldehyde content can be substantially reduced, without affecting the properties of the resin. Further, the alkanolamine-modified phenolic resin formulation of the invention has a viscosity that is relatively stable over extended periods of time at room temperature. Therefore, coated abrasive products can be formed using the alkanolamine-modified phenolic resin formulations of the invention without processing concerns associated with release of formaldehyde and without diminishing stability or other properties of the resin. Further, abrasive products coated with the alkanolamine-modified phenolic resin formulations of the invention can have performance characteristics that are superior to those of coated products employing known phenolic resins.

### BRIEF DESCRIPTION OF THE FIGURES

FIG. 1 is a schematic representation of a cross-sectional view of one embodiment of the coated abrasive product of the invention.

FIG. 2 is a schematic representation of a cross-sectional view of another embodiment of the coated abrasive product of the invention.

### DETAILED DESCRIPTION OF THE INVENTION

The foregoing and other objects, features and advantages of the invention will be apparent from the following more particular description of preferred embodiments of the invention, as illustrated in the accompanying drawings in which like reference characters refer to the same parts throughout the different views. The drawings are not necessarily to scale, emphasis instead being placed upon illustrating the principles of the invention.

The invention generally relates to a process for preparing a stable alkanolamine-modified phenolic resin formulation for abrasive products, and for reducing formaldehyde liberation during manufacturing and/or storage of the abrasive products. The invention also relates to an alkanolamine-modified phenolic resin which is used for improving mechanical and thermal properties of abrasive products. Although not wishing to be limited to any particular mechanism, it is believed that an alkanolamine added as part of the method of the invention operates as a formaldehyde scavenger during resin synthesis to thereby produce a formulation that is relatively stable and which reduces formaldehyde emission during subsequent processing of the resin product.

The method of forming an alkanolamine-modified phenolic resin formulation having a reduced formaldehyde content includes forming a reaction mixture that includes formaldehyde, a benzene-ol and a basic catalyst. As used herein, a “benzene-ol”means a phenol-type compound represented by a structural formula selected from the group consisting of:

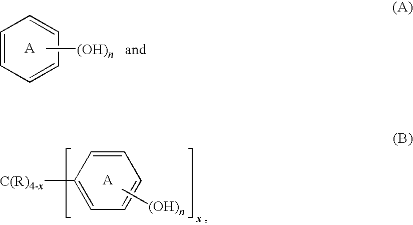

wherein each R is independently —H or an optionally substituted C1-C6 alkyl; each n independently is 1, 2 or 3; and each x is 1, 2 or 3. Preferably, each R is independently —H or an unsubstituted C1-C6 alkyl, such as —CH₃ or —C₂H₅. Ring A is optionally substituted with one or more substituents other than —OH. Suitable substituents include halogen (e.g., F, Cl, Br, I), an alkyl group of C1-C5 (e.g., methyl, ethyl, tert-butyl, n-pentyl, etc.), phenyl and benzyl. Suitable specific examples of phenol-type compounds include phenol (i.e., C₆H₄OH), p-tert-butyl phenol, p-amyl phenol, CH₂(C₆H₄OH)₂ or C(CH₃)₂(C₆H₄OH)₂. In a specific embodiment, ring A is not substituted. Preferably, the benzene-ol is a phenol-type compound represented by structural formula (A). Alternatively, the benzene-ol is a phenol-type compound represented by structural formula (B), wherein each R is independently —H or an unsubstituted C1-C6 alkyl, such as —CH₃ or —C₂H₅. Alternatively, the benzene-ol is a phenol-type compound represented by structural formula (B), wherein each R is independently —H or an unsubstituted C1-C6 alkyl, such as —CH₃ or —C₂H₅, and x is 1 or 2. More preferably, the benzene-ol is a phenol-type compound represented by structural formula (A) and Ring A is not substituted. Even more preferably, the benzene-ol is phenol (i.e., C₆H₅OH). In one embodiment, the benzene-ol is technical grade phenol is employed having a minimum purity of about 94%.

Formaldehyde generally exists in several forms, including the monomeric form represented by H₂CO, the cyclic trimer (troxane) and the polymeric form (paraformaldehyde). Additionally, in water, it exists as the hydrate H₂C(OH)₂. As used herein, a “formaldehyde” includes all of these forms. Any suitable commercially available formaldehyde, including a formaldehyde solution, can be used in the invention. In one embodiment, an aqueous formaldehyde solution is employed in the invention, wherein the aqueous formaldehyde solution has a formaldehyde content of between about 30 wt % and about 38.5 wt %, and preferably between about 35 wt % and about 38.5%, such as about 35 wt %, about 36.5 wt %, about 37 wt %, about 37.5 wt %, 38 wt % and about 38.3 wt %. In a preferred embodiment, methanol is added to the formaldehyde solution to stabilize the formaldehyde and avoid the formation of para-formaldehyde. In a particularly preferred embodiment, the amount of methanol in the aqueous solution is in a range of between about 1 wt % and about 5 wt %, and more preferably about 3.5 wt %. In another embodiment, paraformaldehyde is employed in the invention.

As used herein, an “alkanolamine” means a compound represented by NR′₍₃₋ₓ₎(R″OH)ₓ, wherein x is 1, 2 or 3, particularly 1; R′ is —H or a C1-C10 alkyl group, particularly —H; and R″ is a C1-C10 alkylene group. Each of the alkyl group and alkylene group represented by R′ and R″, respectively, can independently be substituted with one or more substituents. Examples of suitable substituents include halogen (e.g., F, Cl, Br, I), C1-C6 alkoxy, C1-C6 haloalkoxy, C1-C6 haloalkyl, phenyl and benzyl. In a specific embodiment, R′ is —H or a C1-C6 alkyl group (e.g., —CH₃ or —C₂H₅), particularly —H; and R″ is a C1-C6 alkylene group. In one more specific embodiment, x is 1; R′ is —H or a C1-C6 alkyl group (e.g., —CH₃ or —C₂H₅), particularly —H; and R″ is a C1-C6 alkylene group. In another specific embodiment, the alkanolamine is an ethanolamine represented by NR′₍₃₋ₓ₎(C₂H₅OH)ₓ, wherein x is 1, 2 or 3, particularly 1; and R′ is —H or a C1-C10 alkyl group. In another specific embodiment, the ethanolamine is represented by NR′₍₃₋ₓ₎(C₂H₅OH)ₓ, wherein x is 1, 2 or 3, particularly 1; and R′ is —H or a C1-C6 alkyl group, particularly —H. In yet another specific embodiment, the ethanolamine is represented by NH₂(C₂H₅OH) or NH(C₂H₅OH)₂.

Typically, the amount of the benzene-ol, such as phenol, present in the reaction mixture is in a molar ratio to formaldehyde in a range of between about 1:1 and about 1:2.3, and preferably in a molar ratio of about 1:1.73.

The amount of the alkanolamine added is in an amount of between about 0.5 weight % and about 15 weight % (such as between about 0.5 weight % and about 10 wt %, or between about 1 weight % and about 15 wt %, between about 1 weight % and about 10 wt %, between about 5 weight % and about 15 wt %, or between about 5 weight % and about 10 wt %) based on the weight of the benzene-ol combined to form the reaction mixture, i.e., employed for preparing a stable alkanolamine-modified phenolic resin formulation.

Any suitable basic catalyst known in the phenolic resin art can be used in the invention. In one embodiment, a suitable basic catalyst is selected from the group consisting of sodium hydroxide, lithium hydroxide, barium hydroxide and hydrates thereof. Combinations of these catalysts also can be used, for example, a mixture of barium hydroxide and lithium hydroxide. In a preferred embodiment, the basic catalyst is sodium hydroxide. Typically, the amount of sodium hydroxide catalyst is in a range of about 1 wt % and about 5 wt % of the amount of the benzene-ol, such as phenol, in the reaction mixture. In a specific embodiment, the amount of sodium hydroxide catalyst is about 2 wt % of the amount of the benzene-ol, such as phenol, in the reaction mixture. Typically, the amount of the benzene-ol in the reaction mixture is calculated based on the concentration or purity of a source of the benzene-ol.

In one embodiment, the reaction mixture, including formaldehyde and a benzene-ol, is heated to have a temperature in a range of between about 40° C. and about 50° C. to initiate reaction, such as about between about 45° C. and about 50° C. (e.g., about 45° C.). A basic catalyst is then added to the reaction mixture. In a specific embodiment, the temperature of the reaction mixture, into which the basic catalyst is added, does not exceed about 50° C. Preferably, the temperature of the reaction mixture is controlled within about 1° C. In another specific embodiment where paraformaldehyde is employed, the resulting reaction mixture that includes formaldehyde, a benzene-ol and a basic catalyst is kept at a temperature in a range of between about 40° C. and about 50° C. to initiate reaction, such as about between about 45° C. and about 50° C. (e.g., about 45° C.) for at least about 30 minutes, such as for at least about 1 hour, or for about at least about 2 hours (e.g., for about 2.5 hours).

The resulting reaction mixture that includes formaldehyde, benzene-ol and a basic catalyst, in one embodiment, is then heated to have a temperature in a range of between about 50° C. and about 90° C. to initiate reaction. In a specific embodiment, the increase of the temperature of the reaction mixture is made with a rate in a range of between about 1° C./min. and about 10° C./min. The reaction is exothermic and, preferably, controlled within +/−1° C. once a desired maximum reaction temperature is reached. Preferably, the desired maximum reaction temperature is in a range of between about 80° C. and about 95° C., such as between about 80° C. and about 90° C. or between about 85° C. and about 95° C. The amount of time over which the reaction mixture is maintained at the desired maximum temperature can be varied depending upon the scale of the reaction and depending upon the desired water tolerance, which one skilled in the art can determine without undue experimentation in view of the teachings of the present application. Typically, the amount of time over which the reaction mixture is maintained at the desired maximum temperature is less than about 1.5 hours, and most preferably about 1 hour. In a preferred embodiment, the reaction mixture is maintained at a temperature of between about 85° C. and about 95° C. or between about 85° C. and about 90° C. for a reaction period in a range of between about 0.5 hours and about 1.5 hours. Preferably, the temperature of the reaction mixture is controlled using a bath, such as a water bath.

In another embodiment, the reaction mixture, containing paraformaldehyde, benzene-ol and a basic catalyst, is heated to have a temperature in a range of between about 40° C. and about 50° C. to initiate reaction. In a specific embodiment, the increase of the temperature of the reaction mixture is made with a rate in a range of between about 1° C./min. and about 10° C./min. The reaction is exothermic and, preferably, controlled within +/−1° C. once a desired maximum reaction temperature is reached. Preferably, the desired maximum reaction temperature is in a range of between about 45° C. and about 50° C. The amount of time over which the reaction mixture is maintained at the desired maximum temperature can be varied depending upon the scale of the reaction and depending upon the desired water tolerance, which one skilled in the art can determine without undue experimentation in view of the teachings of the present application. Typically, the amount of time over which the reaction mixture is maintained at the desired maximum temperature is less than about 1.5 hours, and most preferably about 1 hour. In a preferred embodiment, the reaction mixture is maintained at a temperature not exceeding about 50° C., such as between about 40° C. and about 50° C., or between about 45° C. and about 50° C., for a reaction period in a range of between about 0.5 hours and about 1.5 hours. Preferably, the temperature of the reaction mixture is controlled using a bath, such as a water bath.

The pH of the reaction mixture preferably is in a range of between about 8.3 and about 9.3, and most preferably is about 8.9. The pH of the reaction mixture can be adjusted with a suitable acid, or by addition of a suitable base. Any suitable acid and base known in the art can be used in the invention. Suitable examples of acids include sulfonic acids, such as p-toluene sulfonic acids, phenolic sulfonic acids, cumene sulfonic acids and methane sulfonic acids, and phosphoric acids. Suitable examples of bases include alkali and/or alkaline metal hydroxides, such as NaOH, LiOH, KOH, Mg(OH)₂, Ca(OH)₂, and Ba(OH)₂, and combinations of thereof, such as a mixture of Ba(OH)₂ and Li(OH).

Molecular weight of a phenolic resin increases during the reaction between the benzene-ol and formaldehyde, and the progress of the reaction can be indicated by water tolerance. Water tolerance generally indicates the approximate molecular weight of the phenolic resin formed from the reaction between the benzene-ol and formaldehyde. Once the reaction progresses, a portion of the reaction mixture, for example, about 10-20 ml of the reaction mixture, is withdrawn for a water tolerance measurement. The withdrawn mixture (W₁ in weight) is poured into a vehicle, such as a glass beaker. Then distilled water (W₂ in weight) is added to the vehicle until turbidity appears. Once turbidity develops then the water tolerance can be calculated as follows:

% water tolerance=(W2)/(W₁)*100. (1)

The reaction between the benzene-ol and formaldehyde is terminated when the water tolerance has reached a suitable percentage, to thereby form an intermediate composition. An example of a suitable water tolerance is a water tolerance in a range of between about 150% and 1000%. Preferably, the water tolerance is in a range of between about 150% and 800%. More preferably, the water tolerance is in a range of between about 150% and 600%. Even more preferably, the water tolerance is in a range of between about 300% and 500%. In a particular embodiment, the water tolerance upon termination of the reaction mixture is about 390%. Termination of the reaction is achieved by adjusting the temperature of the reaction mixture to have a temperature equal to or less than about 50° C., preferably equal to or less than about 40° C. In a preferred embodiment, the temperature of the reaction mixture is in a range of between about 85° C. and about 95° C., more preferably between about 90° C. and about 95° C., and, upon the targeted water tolerance has been reached thereafter, the reaction mixture is cooled to about 40° C. or below. The reduction of the reaction temperature can be done in any suitable method known in the art. In one embodiment, the temperature is reduced by subjecting to the reaction vessel to chilled liquid, such as water, by applying vacuum (e.g., 200-700 mm Hg), and/or by using an evaporation technique. Preferably, the reaction is terminated by subjecting to the reaction vessel to chilled liquid, such as chilled water, and/or by the use of reduced pressure (i.e., by applying vacuum). Preferably, agitation of the reaction mixture continues during cooling. Preferably the rate of cooling is in a range of between about 5° C./min. and about 1° C./min, and most preferably is about 2° C./min.

After cooling the reaction mixture to thereby form the intermediate composition, a suitable amount of an alkanolamine is added to the intermediate composition. The alkanolamine can be mixed with the intermediate composition in any form. In one embodiment, the alkanolamine is added to the intermediate composition in the form of an aqueous solution, such as an alkanolamine solution including an alkanolamine in an amount of between about 50 wt. % and about 99 wt. % of the total solution, the balance of the solution including water. Alternatively, an essentially pure alkanolamine can also be employed in the method of the invention.

The reaction mixture, with an alkanolamine, is then heated to a temperature in a range of between about 50° C. and about 70° C., preferably in a range of between about 55° C. and about 65° C., and more preferably about 60° C. In a preferred embodiment, the raised temperature is maintained for a reaction period to allow the alkanolamine to react with the intermediate composition, for example, at least a portion of the formaldehyde present in the intermediate composition. An optimal value for any particular application of the reaction period can be varied depending upon the scale of the reaction, which one skilled in the art can find without undue experimentation. In a specific embodiment, the reaction period is in a range of between about 45 minutes and about 90 minutes, and more specifically between about 45 minutes and about 75 minutes. In a more specific embodiment, the reaction temperature is maintained at about 60° C. for a period of time of about 60 minutes.

In one embodiment, following the reaction of the alkanolamine, at least a portion of the water present is removed by a suitable method. In one specific embodiment, between about 60 wt % and about 80 wt % of the water present is removed by a suitable method, such as by vacuum distillation. In one embodiment, vacuum distillation is conducted at a temperature in a range of between about 55° C. and about 65° C. Preferably, vacuum distillation is conducted at a temperature of about 60° C.

Preferably, the viscosity of the alkanolamine-modified phenolic resin is in a range of between 500 cps and about 20,000 cps at a temperature of about 25° C. Preferably, the viscosity of the alkanolamine-modified phenolic resin is in a range of between about 2,000 cps and about 10,000 cps, more preferably in a range of between about 2,000 cps and about 5,000 cps, such as about 3000 cps. The viscosity of the alkanolamine-modified phenolic resin typically remains essentially constant for at least about 1 hour. As used herein, “essentially constant” viscosity means that change of viscosity over time is less than about 10% of the original viscosity. Preferably, the viscosity of the alkanolamine-modified phenolic resin remains essentially constant for at least about 3 hours.

Preferably, the alkanolamine-modified phenolic resin has essentially constant water tolerance for at least about 1 hour. As used herein, “essentially constant” water tolerance means that change of water tolerance is less than about 10% of the original water tolerance. Preferably, the water tolerance of the alkanolamine-modified phenolic resin remains essentially constant for at least about 3 hours.

Formaldehyde content of the resulting resin typically is less than about 0.3 wt % of 100 g of the resin, such as in a range of between about 0.1 and about 0.295 wt % of 100 g of the resin. Free formaldehyde content of the resulting resin can be reduced to less than about 0.05 wt % of 100 g of the resin by optimizing the alkanolamine loading and water tolerance during formation of the resin. The content of formaldehyde can be measured by any suitable method known in the art. For example, it can be measured by titration of free formaldehyde (HCHO) with hydroxylamine (NH₂HOH), such as hydroxylamine hydrochloride (NH₂HOH.HCl), as shown in the following reaction:

HCHO+NH₂HOH.HCl→H₂O+CH₂NOH+HCl (2)

The hydrochloric acid formed in reaction (2) is potentiometrically determined with a reagent grade NaOH solution.

The term “alkyl” used alone or as part of a larger moiety, such as “alkoxy”, “haloalkyl”, and the like, includes as used herein means saturated straight-chain, cyclic or branched aliphatic group. Typically, an alkyl group includes 1-10 carbon atoms. In some embodiments, an alkyl group includes 1-6 carbon atoms, specifically, 1-5 carbon atoms. Alternatively, an alkyl group includes 1-4 carbon atoms.

The term “alkoxy” means —O-alkyl.

The terms “haloalkyl” and “haloalkoxy” means alkyl or alkoxy, as the case may be, substituted with one or more halogen atoms. The term “halogen” means F, Cl, Br or I. Preferably the halogen in a haloalkyl or haloalkoxy is F or Cl.

An “alkylene group” is represented by —[CH₂]_{z}—, wherein z is a positive integer, such as from one to ten, from one to six, or from one to four.

The curable resin composition of the invention includes an alkanolamine-modified phenolic resin formulation prepared by the method described above. As used herein, an uncured or uncrosslinked “resin” is a composition for curing or crosslinking, comprising one or more components selected from monomers, oligomers, and polymers, and may optionally contain other additives such as colorants, stabilizers, plasticizers, fillers, solvents, antiloading agents, or the like. Generally, a resin includes a mixture of partially polymerized components that harden upon curing, which is typically the result of a crosslinking reaction. The uncured or uncrosslinked resin can be cured by initiation with light, electron beam radiation, acid, base, heat and combinations thereof.

The curable resin composition of the invention, including an alkanolamine-modified phenolic resin formulation prepared by the method described above, can be employed as a resin binder in abrasive products, such as bonded abrasive products (e.g., abrasive wheels, disks and horns) and coated abrasive products (e.g., abrasive films and papers). In one embodiment, the abrasive product of the invention includes a plurality of abrasive particles and a resin binder cured from the resin composition. The resin composition can be blended with a plurality of abrasive particles or, in the alternative, applied over abrasive particles and then cured to form a make coat or a size coat over a base layer and the plurality of abrasive particles of an abrasive product. After application of the resin composition, either as a bond, a make coat or a size coat, the resin composition is cured under suitable conditions, such as one known in the art.

In one embodiment, the abrasive product of the invention is a coated abrasive product that includes a base layer, a plurality of abrasive particles, and a resin coat attaching the plurality of abrasive particles to the base layer. The resin coat is cured from a curable resin composition of the invention described above. In another embodiment, the abrasive product of the invention is a bonded abrasive product that includes a plurality of abrasive powders and a resin binder cured from a curable resin composition as described above. In the bonded abrasive product, the abrasive powders are typically bonded together with the use of the resin binder, and form a three-dimensional shape, such as a wheel.

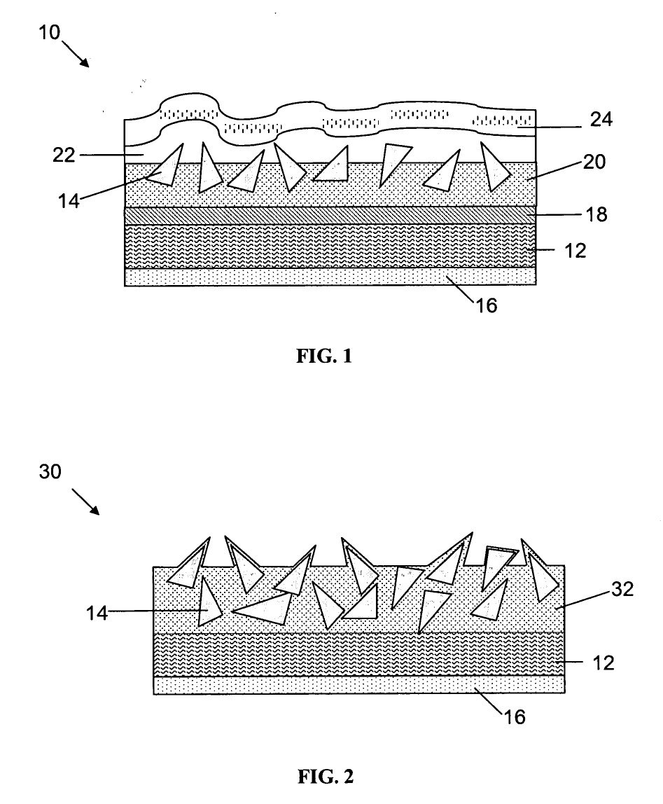

The coated abrasive product of the invention generally includes a substrate (i.e., base layer), abrasive particles and at least one binder to hold the abrasive particles to the substrate. As used herein, the term “coated abrasive product” encompasses a nonwoven abrasive product. FIGS. 1 and 2 show coated abrasive products 10 and 30 of the invention. Referring to FIG. 1, in coated abrasive product 10, substrate 12 is treated with optional backsize coat 16 and optional presize coat 18. Overlaying the optional presize coat 18 is make coat 20 to which abrasive material 14, such as abrasive grains or particles, are applied. Size coat 22 is optionally applied over make coat 20 and abrasive particles 14. Overlaying size coat 22 is optional supersize coat 24. Depending upon their specific applications, coated abrasive product 10 may or may not include backsize coat 16 and/or presize coat 18. Also, depending upon their specific applications, coated abrasive product 10 may or may not include size coat 22 and/or supersize coat 24. Shown in FIG. 2 is coated abrasive product 30 that includes a single layer of abrasive particles 14 and adhesive(s) (binder-abrasive layer 32) and optionally backsize coat 16. Optionally, presize coat 18, size coat 22 and supersize coat 24, as shown in FIG. 1, can be included in coated abrasive product 30.

In some embodiments, a curable resin composition of the invention is used in forming at least one layer selected from the group consisting of binder-abrasive layer 32, backsize coat 16, presize coat 18, make coat 20, size coat 22 and supersize coat 24. In a specific embodiment, a curable resin composition of the invention is used in forming at least one adhesive layer selected from the group consisting of presize coat 18, make coat 20 and size coat 22. In a preferred embodiment, a curable resin composition of the invention is used to form a binder for affixing abrasive particles 14 to substrate 12, for example, for forming binder-abrasive layer 32 or at least one coat of coats 20 (make coat) and 22 (size coat). In a specifically preferred embodiment, a curable resin composition of the invention is used to form a binder for binder-abrasive layer 32. In these embodiments, abrasive particles 14 can be applied separately by gravity, electrostatic deposition or in air stream, or as slurry together with the curable resin composition.

Substrate 12 may be impregnated either with a resin-abrasive slurry or a resin binder without abrasive grains, depending upon the required aggressiveness of the finished coated abrasive tools, as described above. Substrate 12 useful in the invention can be rigid, but generally is flexible. Substrate 12 can be paper, cloth, film, fiber, polymeric materials, nonwoven materials, vulcanized rubber or fiber, etc., or a combination of one or more of these materials, or treated versions thereof. The choice of the substrate material generally depends on the intended application of the coated abrasive tool to be formed. In a preferred embodiment, substrate 12 is a nonwoven material. As used herein, “nonwoven” means a web of random or directional fibers held together mechanically, chemically, or physically, or any combination of these. Examples of nonwoven materials include fibers formed into a nonwoven web that provides as a three-dimensional integrated network structure. Any fibers known to be useful in nonwoven abrasive tools can be employed in the invention. Such fibers are generally formed from various polymers, including polyamides, polyesters, polypropylene, polyethylene and various copolymers thereof. Cotton, wool, blast fibers and various animal hairs can also be used for forming nonwoven fibers. In some applications, the nonwoven substrate can include a collection of loose fibers, to which abrasive particles 14 are added to provide an abrasive web having abrasive particles 14 throughout.

Depending upon which adhesive layer(s) the curable resin composition of the invention is utilized for, abrasive particles 14 are applied over a substrate prior to, after and/or simultaneously with the application of the curable resin composition to the substrate. Abrasive particles 14 can be applied over substrate 12 by spraying (via gravity, electrostatic deposition or air stream) or by coating. In a specific embodiment, abrasive particles 14 are applied over substrate 12 simultaneously with the curable resin composition. In one example of this embodiment, as shown in FIG. 2, the curable resin composition and abrasive particles are mixed together to form a binder-abrasive composition slurry, and the slurry is applied over substrate 12 to form single binder-abrasive composition layer 32. In another specific embodiment, abrasive particles 14 are applied over a coating of the curable resin composition. In one example of this embodiment, the curable resin composition is used for forming at least one of the backsize, presize and make coats. In yet another embodiment, abrasive particles 14 are applied prior to the application of the curable resin composition to substrate 12. In one example of this embodiment, the curable resin composition is used for forming at least one of the size and supersize coats.

A suitable material for abrasive particles 14 useful in the invention can be of any conventional abrasive particle material utilized in the formation of coated abrasive tools. Examples of suitable abrasive particle materials for use in the invention include diamond, corundum, emery, garnet, chert, quartz, sandstone, chalcedony, flint, quartzite, silica, feldspar, pumice and talc, boron carbide, cubic boron nitride, fused alumina, ceramic aluminum oxide, heat treated aluminum oxide, alumina zirconia, glass, silicon carbide, iron oxides, tantalum carbide, cerium oxide, tin oxide, titanium carbide, synthetic diamond, manganese dioxide, zirconium oxide, and silicon nitride. The abrasive materials can be oriented or can be applied to the substrate without orientation (i.e., randomly), depending upon the particular desired properties of the coated abrasive tools. In choosing an appropriate abrasive material, characteristics, such as size, hardness, compatibility with workpieces and heat conductivity, are generally considered. Abrasive particle materials useful in the invention typically have a particle size ranging from about 0.1 micrometer and about 1,500 micrometers, such as from about 10 micrometers to about 1000 micrometers.

The adhesive layer(s) of coated abrasive products 10 and 30 can be made by any suitable method, such as one generally known in the art. In one embodiment, optional backsize coat 16 and optional presize coat 18, not containing abrasive particles 14, are coated on substrate 12 and cured by exposure to heat in order to impart sufficient strength to substrate 12 for further processing. Then, make coat 20 is applied to substrate 12 to secure abrasive particles 14 throughout substrate 12, and while the coat is still tacky, abrasive particles 14 are applied over make coat 20. The make coat is subsequently cured so as to hold abrasive particles 14 in place. Thereafter, size coat 22 is applied over substrate 12, and then cured. The primary function of size coat 22 generally is to anchor abrasive particles 14 in place and allow them to abrade a workpiece without being pulled from the coated abrasive structure before their grinding capability has been exhausted. In another embodiment, a slurry of abrasive particles 14 and a resin binder composition described above, is applied over substrate 12, optionally on presize coat 18 over substrate 12, and then cured.

In some cases, supersize coat 24 is deposited over size coat 22. Supersize coat 24 can be deposited with or without a binder, as described above. Generally, the function of supersize coat 24 is to place on a surface of coated abrasive materials 14 an additive that provides special characteristics, such as enhanced grinding capability, surface lubrication, anti-static properties or anti-loading properties. Examples of suitable grinding aids include KBF₄ and calcium carbonate. Examples of suitable lubricants for supersize coat 24 include lithium stearate. Examples of suitable anti-static agent include alkali metal sulfonates, tertiary amines and the like. Examples of suitable anti-loading agents include metal salts of fatty acids, for example, zinc stearate, calcium stearate, lithium stearate, sodium laurel sulfate and the like. Anionic organic surfactants can also be used effective anti-loading agents. A variety of examples of such anionic surfactants and antiloading compositions including such an anionic surfactant are described in U.S. Patent Application Publication No. 2005/0085167 A1, the entire teachings of which are incorporated herein by reference. Other examples of suitable anti-loading agents include inorganic anti-loading agents, such as metal silicates, silicas, metal carbonates and metal sulfates. Examples of such inorganic anti-loading agents can be found in WO 02/062531, the entire teachings of which are incorporated herein by reference.

In some specific embodiments, the coated abrasive product of the invention includes a nonwoven substrate, such as a nonwoven substrate made from an air-laid process which is well known in the art. The nonwoven substrate is impregnated with a coating composition disclosed above, and an abrasive material, such as fine abrasive particles. The uncured, impregnated nonwoven substrate is wound spirally to form a log. Alternatively, the uncured impregnated nonwoven substrate is cut into sheets and the sheets are stacked between two metal plates to form a slab. The log or slab is then heated to form the nonwoven abrasive tool. Optionally, the cured log or slab is converted into a final shape normally used for polishing, deburring, or finishing applications in the metal or wood industries.

The curable resin composition of the invention can optionally further include one or more additives, such as fillers, coupling agents, fibers, lubricants, surfactants, pigments, dyes, wetting agents, grinding aids, anti-loading agents, anti-static agents and suspending agents. Specific additive(s) that is included in the resin composition can be chosen depending upon for which adhesive layer(s) (e.g., coats 16, 18, 20, 22, 24 and 32 of FIGS. 1 and 2) the resin composition is employed. For example, as discussed above, supersize coat 24 can include one or more anti-loading agents. One or more grinding aids can be included in size coat 22 and/or make coat 20. The amounts of these materials are selected, depending upon desired properties to achieve.

The abrasive product of the invention can generally take the form of sheets, discs, belts, bands, and the like, which can be further adapted to be mounted on pulleys, wheels, or drums. The coated abrasive product of the invention can be used for sanding, grinding or polishing various surfaces of, for example, steel and other metals, wood, wood-like laminates, plastics, fiberglass, leather or ceramics. In one embodiment, the abrasive product of the invention is used for abrading a work surface by applying the abrasive product in an abrading motion to remove a portion of the work surface.

### EQUIVALENTS

While this invention has been particularly shown and described with references to example embodiments thereof, it will be understood by those skilled in the art that various changes in form and details may be made therein without departing from the scope of the invention encompassed by the appended claims.

What is claimed is:

1. A method of forming an alkanolamine-modified phenolic resin having a reduced formaldehyde content, comprising the steps of:
a) combining a basic catalyst, formaldehyde, water and a benzene-ol to form a reaction mixture undergoing chemical reaction;
b) terminating the chemical reaction of the reaction mixture when water tolerance of the reaction mixture is in a range of between about 150% and about 1,000% to thereby form an intermediate composition; and
c) adding an alkanolamine to the intermediate composition in an amount of between about 0.5 weight % and about 15 weight % based on the weight of the benzene-ol combined to form the reaction mixture, whereby the alkanolamine undergoes chemical reaction with the intermediate composition to thereby form the alkanolamine-modified phenolic resin.

2. The method of claim 1, wherein the benzene-ol is phenol.

3. The method of claim 1, further including removing at least a portion of the water present in a reaction mixture resulted from step c).

4. The method of claim 1, wherein the alkanolamine is NH₂(C₂H₅OH) or NH(C₂H₅OH).

5. The method of claim 1, wherein the basic catalyst is selected from the group consisting of sodium hydroxide, lithium hydroxide, barium hydroxide and hydrates thereof, and a combination thereof.

6. The method of claim 5, wherein the basic catalyst is sodium hydroxide.

7. The method of claim 6, wherein the amount of the sodium hydroxide is between about 1 weight % and about 5 weight % of the amount of the benzene-ol combined to form the reaction mixture.

8. The method of claim 7, wherein the amount of the sodium hydroxide is about 2 weight % of the amount of the benzene-ol combined to form the reaction mixture.

9. The method of claim 1, wherein the alkanolamine added to the intermediate composition is in an aqueous medium.

10. The method of claim 9, wherein the amount of the alkanolamine added to the intermediate composition is in a range of between about 5 weight % and about 10 weight % of the amount of the benzene-ol combined to form the reaction mixture.

11. The method of claim 10, wherein the amount of the alkanolamine added to the reaction mixture is about 5 weight % of the amount of the benzene-ol combined to form the reaction mixture.

12. The method of claim 1, wherein the chemical reaction of the reaction mixture is terminated by adjusting the temperature of the reaction mixture to a temperature equal to or less than about 50° C.

13. The method of claim 12, wherein the temperature of the reaction mixture is adjusted to a temperature equal to or less than about 40° C.

14. The method of claim 1, wherein the chemical reaction is terminated when the water tolerance of the reaction mixture is in a range of between about 300% and about 500%.

15. The method of claim 1, wherein reaction of the reaction mixture is initiated by exposing the reaction mixture to a temperature in a range of between about 50° C. and about 90° C.

16. The method of claim 15, wherein the reaction mixture is maintained at a temperature of between about 85° C. and about 95° C. for a reaction period in a range of between about 30 minutes hours and about 90 minutes.

17. The method of claim 16, wherein the alkanolamine is allowed to react with the intermediate composition at a temperature in a range of between about 50° C. and about 70° C.

18. The method of claim 17, wherein the temperature is maintained for a reaction period in a range of between about 45 minutes and about 90 minutes.

19. The method of claim 18, wherein the mixture of the alkanolamine and the intermediate composition is maintained at a temperature of about 60° C. for a period of time of about 60 minutes.

20. The method of claim 1, wherein the water content of the intermediate composition is at least about 50 wt % of the total weight of the intermediate composition.

21. A resin formulation comprising an alkanolamine-modified phenolic resin, the alkanolamine-modified-modified phenolic resin being formed by a method comprising the steps of:
a) combining a basic catalyst, formaldehyde, water and a benzene-ol to form a reaction mixture undergoing chemical reaction;
b) terminating the chemical reaction of the reaction mixture when water tolerance of the reaction mixture is in a range of between about 150% and about 1,000% to thereby form an intermediate composition; and
c) adding an alkanolamine to the intermediate composition in an amount of between about 0.5 weight % and about 15 weight % based on the weight of the benzene-ol combined to form the reaction mixture, whereby the alkanolamine undergoes chemical reaction with the intermediate composition to form the alkanolamine-modified phenolic resin.

22. The resin formulation of claim 21, wherein the benzene-ol is phenol.

23. The resin formulation of claim 21, wherein the alkanolamine is NH₂(C₂H₅OH) or NH(C₂H₅OH).

24. The resin formulation of claim 21, wherein viscosity of the alkanolamine-modified phenolic resin remains essentially constant for at least about 1 hour.

25. The resin formulation of claim 21, wherein water tolerance of the alkanolamine-modified phenolic resin remains essentially constant for at least about 1 hour.

26. The resin formulation of claim 21, wherein the alkanolamine-modified phenolic resin has a free formaldehyde content of between about 0.01 weight % and about 0.3 weight % of 100 g of the resin.

27. The resin formulation of claim 26, wherein the alkanolamine-modified phenolic resin has a free formaldehyde content of between about 0.05 weight % and about 0.2 weight % of 100 g of the resin.

28. The resin formulation of claim 21, wherein the basic catalyst is selected from the group consisting of sodium hydroxide, lithium hydroxide, barium hydroxide and hydrates thereof, and a combination thereof.

29. The resin formulation of claim 28, wherein the basic catalyst is sodium hydroxide.

30. The resin formulation of claim 29, wherein the amount of the sodium hydroxide is between about 1 weight % and about 5 weight % of the amount of the benzene-ol combined to form the reaction mixture.

31. The resin formulation of claim 30, wherein the amount of the sodium hydroxide is about 2 weight % of the amount of the benzene-ol combined to form the reaction mixture.

32. The resin formulation of claim 21, wherein the alkanolamine added to the intermediate composition is in an aqueous medium.

33. The resin formulation of claim 32, wherein the amount of the alkanolamine added to the intermediate composition is in a range of between about 5 weight % and about 10 weight % of the amount of the benzene-ol combined to form the reaction mixture.

34. The resin formulation of claim 33, wherein the amount of the alkanolamine added to the reaction mixture is about 5 weight % of the amount of the benzene-ol combined to form the reaction mixture.

35. The resin formulation of claim 21, wherein the chemical reaction of the reaction mixture is terminated by adjusting the temperature of the reaction mixture to a temperature equal to or less than about 50° C.

36. The resin formulation of claim 21, wherein the chemical reaction is terminated when the water tolerance of the reaction mixture is in a range of between about 300% and about 500%.

37. The resin formulation of claim 21, wherein reaction of the reaction mixture is initiated by exposing the reaction mixture to a temperature in a range of between about 50° C. and about 90° C.

38. The resin formulation of claim 37, wherein the alkanolamine is allowed to react with the intermediate composition at a temperature in a range of between about 50° C. and about 70° C.

39. The resin formulation of claim 21, wherein the water content of the intermediate composition is at least about 50 wt % of the total weight of the intermediate composition.

40. The resin formulation of claim 21, wherein the alkanolamine-modified phenolic resin has a viscosity in a range of between about 2,000 cps and about 20,000 cps at about 25° C.

41. A method of preparing an abrasive product, comprising the steps of:
a) forming a curable resin composition that includes an alkanolamine-modified phenolic resin, the alkanolamine-modified phenolic resin being formed by a method including:
i) combining a basic catalyst, formaldehyde, water and a benzene-ol to form a reaction mixture undergoing chemical reaction,
ii) terminating the chemical reaction of the reaction mixture when water tolerance of the reaction mixture is in a range of between about 150% and about 1,000% to thereby form an intermediate composition, and
iii) adding an alkanolamine to the intermediate composition in an amount of between about 0.5 weight % and about 15 weight % based on the weight of the benzene-ol combined to form the reaction mixture, whereby the alkanolamine undergoes chemical reaction with the intermediate composition to form the alkanolamine-modified phenolic resin formulation;
b) contacting a plurality of abrasive particles with the curable resin composition; and
c) curing the curable composition to produce the abrasive product.

42. An abrasive product formed by a method comprising the steps of:
a) forming a curable resin composition that includes an alkanolamine-modified phenolic resin, the alkanolamine-modified phenolic resin formulation being formed by a method including:
i) combining a basic catalyst, formaldehyde, water and a benzene-ol to form a reaction mixture undergoing chemical reaction,
ii) terminating the chemical reaction of the reaction mixture when water tolerance of the reaction mixture is in a range of between about 150% and about 1,000% to thereby form an intermediate composition, and
iii) adding an alkanolamine to the intermediate composition in an amount of between about 0.5 weight % and about 15 weight % based on the weight of the benzene-ol combined to form the reaction mixture, whereby the alkanolamine undergoes chemical reaction with the intermediate composition to form the alkanolamine-modified phenolic resin;
b) contacting a plurality of abrasive particles with the curable resin composition; and
c) curing the curable composition to produce the abrasive product.

43. The abrasive product of claim 42, wherein the benzene-ol is phenol.

44. The abrasive product of claim 42, wherein the alkanolamine is NH₂(C₂H₅OH) or NH(C₂H₅OH).

45. The abrasive product of claim 42, wherein viscosity of the alkanolamine-modified phenolic resin remains essentially constant for at least about 1 hour.

46. The abrasive product of claim 42, wherein water tolerance of the alkanolamine-modified phenolic resin independently remains essentially constant for at least about 1 hour.

47. The abrasive product of claim 42, wherein the alkanolamine-modified phenolic resin formulation has a free formaldehyde content of between about 0.01 weight % and about 0.3 weight % of 100 g of the resin.

48. The abrasive product of claim 42, wherein the alkanolamine-modified phenolic resin has a free formaldehyde content of between about 0.05 weight % and about 0.2 weight % of 100 g of the resin.

49. A method of forming a coated abrasive product, comprising the steps of:
a) combining a basic catalyst, formaldehyde, water and a benzene-ol to form a reaction mixture undergoing chemical reaction;
b) terminating the chemical reaction of the reaction mixture when water tolerance of the reaction mixture is in a range of between about 150% and about 1,000% to thereby form an intermediate composition;
c) adding an alkanolamine to the intermediate composition in an amount of between about 0.5 weight % and about 15 weight % based on the weight of the benzene-ol combined to form the reaction mixture, whereby the alkanolamine undergoes chemical reaction with the intermediate composition to form an alkanolamine-modified phenolic resin;
d) applying a curable coating that includes the alkanolamine-modified phenolic resin to an abrasive product; and
e) curing the coating, to thereby form the coated abrasive product.

50. A coated abrasive product, formed by a method comprising the steps of:
a) combining a basic catalyst, formaldehyde, water and a benzene-ol to form a reaction mixture undergoing chemical reaction;
b) terminating the chemical reaction of the reaction mixture when water tolerance of the reaction mixture is in a range of between about 150% and about 1,000% to thereby form an intermediate composition;
c) adding an alkanolamine to the intermediate composition in an amount of between about 0.5 weight % and about 15 weight % based on the weight of the benzene-ol combined to form the reaction mixture, whereby the alkanolamine undergoes chemical reaction with the intermediate composition to form an alkanolamine-modified phenolic resin;
d) applying a curable coating that includes the alkanolamine-modified phenolic resin to an abrasive product; and
e) curing the coating, to thereby form the coated abrasive product.

51. The coated abrasive product of claim 50, wherein the benzene-ol is phenol.

52. The coated abrasive product of claim 51, wherein the alkanolamine is NH₂(C₂H₅OH) or NH(C₂H₅OH).

53. The coated abrasive product of claim 50, wherein viscosity of the alkanolamine-modified phenolic resin remains essentially constant for at least about 1 hour.

54. The coated abrasive product of claim 50, wherein water tolerance of the alkanolamine-modified phenolic resin remains essentially constant for at least about 1 hour.

55. The coated abrasive product of claim 50, wherein the alkanolamine-modified phenolic resin has a free formaldehyde content of between about 0.01 weight % and about 0.3 weight % of 100 g of the resin.

56. The coated abrasive product of claim 55, wherein the alkanolamine-modified phenolic resin has a free formaldehyde content of between about 0.05 weight % and about 0.2 weight % of 100 g of the resin.

57. A bonded abrasive product, formed by a method comprising the steps of:
a) combining a basic catalyst, formaldehyde, water and a benzene-ol to form a reaction mixture undergoing chemical reaction;
b) terminating the chemical reaction of the reaction mixture when water tolerance of the reaction mixture is in a range of between about 150% and about 1,000% to thereby form an intermediate composition;
c) adding an alkanolamine to the intermediate composition in an amount of between about 0.5 weight % and about 15 weight % based on the weight of the benzene-ol combined to form the reaction mixture, whereby the alkanolamine undergoes chemical reaction with the intermediate composition to form an alkanolamine-modified phenolic resin;
d) mixing a curable resin composition that includes the alkanolamine-modified phenolic resin with abrasive particles;
d) forming the mixture of the curable resin composition and the abrasive particles into a desired shape; and
e) curing the curable resin composition, to thereby form the bonded abrasive product.

58. The bonded abrasive product of claim 57, wherein the benzene-ol is phenol.

59. The bonded abrasive product of claim 57, wherein the alkanolamine is NH₂(C₂H₅OH) or NH(C₂H₅OH).

60. The bonded abrasive product of claim 57, wherein viscosity of the alkanolamine-modified phenolic resin remains essentially constant for at least about 1 hour.

61. The bonded abrasive product of claim 57, wherein water tolerance of the alkanolamine-modified phenolic resin remains essentially constant for at least about 1 hour.

62. The bonded abrasive product of claim 57, wherein the alkanolamine-modified phenolic resin has a free formaldehyde content of between about 0.01 weight % and about 0.3 weight % of 100 g of the resin.

63. The bonded abrasive product of claim 62, wherein the alkanolamine-modified phenolic resin has a free formaldehyde content of between about 0.05 weight % and about 0.2 weight % of 100 g of the resin.

64. A method of forming an alkanolamine-modified phenolic resin formulation having a reduced formaldehyde content, comprising the steps of:
a) combining,
i. formaldehyde,
ii. phenol, in a molar ratio to the formaldehyde in a range of between about 1:1 and 1:2.3,
iii. sodium hydroxide, in an amount in a range of between about 1% and about 5% by weight of phenol,
to thereby form a reaction mixture undergoing chemical reaction;
b) adjusting temperature of the reaction mixture to have a temperature in a range of between about 85° C. and about 95° C.;
c) terminating reaction of the reaction mixture by reducing the temperature to a temperature equal to or lower than about 50° C., when water tolerance of the reaction mixture is in a range of between about 150% and about 1,000%, to thereby form an intermediate composition;
d) adding an alkanolamine to the intermediate composition in an amount of between about 0.5 weight % and about 15 weight % based on the weight of the phenol combined to form the reaction mixture; and
e) adjusting temperature of the mixture of the alkanolamine and the intermediate composition to a temperature in a range of between about 55° C. and about 65° C., whereby the alkanolamine undergoes chemical reaction with the intermediate composition to thereby obtain the alkanolamine-modified phenolic resin formulation is formed.
